(19) United States
(12) Patent Application Publication
(10) Pub. No.: US 2024/0111989 A1
(43) Pub. Date: Apr. 4, 2024

(54) SYSTEMS AND METHODS FOR PREDICTING CHANGE POINTS

(71) Applicant: Capital One Services, LLC, McLean, VA (US)

(72) Inventors: Aamer CHARANIA, Flower Mound, TX (US); Abhisek JANA, Herndon, VA (US); Jiankun LIU, Flower Mound, TX (US); Behrouz Saghafi KHADEM, Frisco, TX (US)

(73) Assignee: Capital One Services, LLC, McLean, VA (US)

(21) Appl. No.: 17/957,069

(22) Filed: Sep. 30, 2022

(51) Int. Cl. G06N 3/04; G06F 16/901; G06N 3/08

(52) U.S. Cl. CPC G06N 3/04; G06F 16/9024; G06N 3/08

(57) ABSTRACT

Systems and methods for predicting change points in tabular data. In some aspects, the systems and methods provide for generating time-stamped graphs based on data entries and corresponding time stamps. Each graph of the time-stamped graphs corresponds to a data entry and is representative of one or more events associated with a time stamp corresponding to the data entry. The graph is independent of any events before or after the time stamp. For each graph of the time-stamped graphs, a set of graph embeddings is generated based on the graph and processed using a machine learning model to predict an occurrence of a change point in the data entries.

### BACKGROUND

In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence often relies on large amounts of high-quality data. The process for obtaining this data and ensuring it is high-quality is often complex and time-consuming. Second, despite the mainstream popularity of artificial intelligence, practical implementations of artificial intelligence require specialized knowledge to design, program, and integrate artificial intelligence-based solutions, which limits the amount of people and resources available to create these practical implementations. Finally, results based on artificial intelligence are notoriously difficult to review, as the process by which the results are made may be unknown or obscured. This obscurity creates hurdles for identifying errors in the results, as well as improving the models providing the results. These technical problems present an inherent problem with attempting to use an artificial intelligence-based solution for predicting change points in tabular data.

### SUMMARY

Methods and systems are described herein for novel uses and/or improvements to artificial intelligence applications for predicting change points. As one example, methods and systems are described herein for a graph-based approach for predicting one or more change points in time-stamped tabular data representing events occurring at different times.

Conventional systems failed to accurately predict change points in tabular data. For example, conventional systems for analyzing tabular data to predict change points looked at each row or data entry independently, while the graph-based approach described herein leverages relationships across rows to predict change points on a node level basis. Further, the difficulty in adapting artificial intelligence models for this practical benefit faces several technical challenges, such as inability to create feature inputs representative of the technical problem to be addressed, resulting in conventional systems lacking accuracy.

To overcome these technical deficiencies in adapting artificial intelligence models for this practical benefit, methods and systems disclosed herein provide for a graph-based approach that predicts change points in tabular data using time-stamped graphs generated based on data entries from the tabular data. For example, the time-stamped graphs provide superior accuracy compared to existing approaches. In particular, the time-stamped graphs for each data entry capture a snapshot of events for an associated time stamp but are independent of any events before or after the associated time stamp. The graph-based approach converts the tabular data into time-stamped graphs, generates sets of graph embeddings based on the time-stamped graphs, and processes the sets of graph embeddings using a machine learning model to predict the occurrence of a change point on a node level basis. Accordingly, the methods and systems provide the practical benefit of improving prediction of change points from time-stamped tabular data.

In some aspects, a system for predicting one or more change points in time-stamped tabular data representing events occurring at different times includes one or more processors and a non-transitory, computer-readable medium comprising instructions that, when executed by the one or more processors, cause operations. The operations include receiving in tabular form a plurality of data entries and corresponding time stamps. Each data entry of the plurality of data entries includes one or more events associated with a time stamp corresponding to the data entry. The operations include generating a plurality of time-stamped graphs based on the plurality of data entries. Each graph of the plurality of time-stamped graphs corresponds to a data entry of the plurality of data entries and is representative of one or more events associated with a time stamp corresponding to the data entry. The graph is independent of any events before or after the time stamp. The operations include generating, for each graph of the plurality of time-stamped graphs, a set of graph embeddings based on the graph, the set of graph embeddings representing nodes and edges of the graph at a time stamp associated with the graph. The operations include processing, using a machine learning model, sets of graph embeddings for the plurality of time-stamped graphs to predict an occurrence of a change point for a node common to the plurality of time-stamped graphs and determining a time stamp associated with the predicted occurrence of the change point for the node.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for tabular data and corresponding time-stamped graphs used to predict change points in the tabular data, in accordance with one or more embodiments.

FIG. 2A shows an illustrative diagram for time-stamped graphs generated based on data entries from tabular data, in accordance with one or more embodiments.

FIG. 2B shows an illustrative diagram for predicting change points in tabular data, in accordance with one or more embodiments.

FIG. 3 shows illustrative components for a system used to predict change points in tabular data, in accordance with one or more embodiments.

FIG. 4 shows a flowchart of the steps involved in predicting change points in tabular data, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

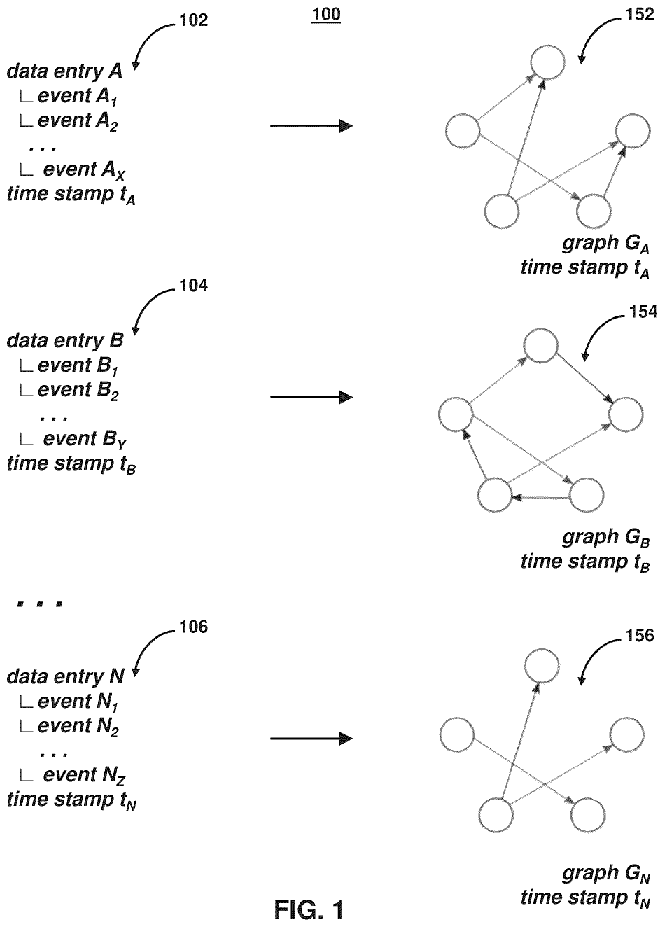

FIG. 1 shows an illustrative diagram 100 for tabular data and corresponding time-stamped graphs used to predict change points in the tabular data, in accordance with one or more embodiments. For example, FIG. 1 illustrates a time-stamped graph that represents events associated with a time stamp and is independent of any events before or after the associated time stamp. Therefore, the events represented in a given graph do not overlap with the events represented in another graph. This is because each graph represents a snapshot of events occurring during a suitable period of time represented by the time stamp associated with the graph. Conventional systems for analyzing tabular data to predict such features looked at each row or data entry independently, while the system may use the graph-based approach that leverages relationships across rows to predict relevant features.

In some embodiments, the time-stamped tabular data that is received may include data entries A, B, . . . , N and associated time stamps t_{A}, t_{B}, . . . , t_{N}. This time-stamped tabular data may be considered to represent a time series where a series of events are indexed in order by the associated time stamps. For example, FIG. 1 shows data entries 102, 104, and 106 (corresponding to data entries A, B, and N). In some embodiments, the data entries and associated time stamps may be received separately (e.g., from different sources, or in different files, etc.). In some embodiments, the data entries and associated time stamps may be received together (e.g., from the same source, or in the same file, etc.).

Data entry A includes information regarding events A₁, A₂, . . . . A_{X} associated with time stamp t_{A}. For example, events A₁, A₂, . . . , A_{X} may represent X transactions (or another suitable event) occurring on a particular day or hour (or another suitable period of time) represented by time stamp t_{A}. Similarly, data entry B includes information regarding events B₁, B₂, . . . , B_{Y} associated with time stamp t_{B}. For example, events B₁, B₂, . . . , B_{Y} may represent Y transactions (or another suitable event) occurring on a particular day (or another suitable period of time) represented by time stamp t_{B}. The events from data entry A do not overlap with the events from data entry B. This is because each data entry represents a snapshot of events occurring during a suitable period of time represented by the time stamp associated with the data entry. Therefore, events from data entry A occurred during a period of time represented by time stamp t_{A}, while events from data entry B occurred during a period of time represented by time stamp t_{B}.

Similarly, data entry N includes information regarding events N₁, N₂, . . . , N_{Z} associated with time stamp t_{N}. For example, events N₁, N₂, . . . , N_{Z} may represent Z transactions (or another suitable event) occurring on a particular day (or another suitable period of time) represented by time stamp t_{N}. The number of events represented by each data entry may vary, and any such variations should be considered within the scope and spirit of this disclosure. The events from data entry N do not overlap with the events from data entry A or data entry B. This is because each data entry represents a snapshot of events occurring during a suitable period of time represented by the time stamp associated with the data entry. Therefore, events from data entry N occurred during a period of time represented by time stamp t_{N}, while events from data entry A and data entry B occurred during periods of time represented by time stamp t_{A} and time stamp t_{B}, respectively.

In some embodiments, each data entry (or row or another suitable portion) of the time-stamped tabular data is converted into a corresponding graph representation. For example, for a given data entry, one or more events and the entities involved may be identified. The corresponding graph representation or graph for the data entry, also referred to herein as a “time-stamped graph,” may include the entities as nodes and the events involving the entities may be indicated via edges connecting the appropriate nodes. For example, FIG. 1 shows data entries 102, 104, and 106 (corresponding to data entries A, B, and N) and associated time-stamped graphs 152, 154, and 156 (corresponding to graphs G_{A}, G_{B}, and G_{N}). In some embodiments, the data entries and associated time-stamped graphs may be received separately (e.g., from different sources, or in different files, etc.). In some embodiments, the data entries and associated time-stamped graphs may be received together (e.g., from the same source, or in the same file, etc.). In some embodiments, the data entries may be received, and the associated time-stamped graphs may be subsequently generated. In some embodiments, the data entries may be received at a remote location, the associated time-stamped graphs may be generated at the remote location, and only the time-stamped graphs may be received from the remote location.

Graph G_{A} includes nodes and edges representing events from data entry A. For example, the events A₁, A₂, . . . , A_{X} may represent X transactions (or another suitable event) between multiple entities occurring on a particular day or hour (or another suitable period of time) represented by time stamp t_{A}, and in graph G_{A}, each node may represent an entity, and each edge may represent a transaction between the nodes connected by the edge occurring on a particular day or hour (or another suitable period of time) represented by time stamp t_{A}. Similarly, graph G_{B} includes nodes and edges representing events from data entry B. For example, the events B₁, B₂, . . . , B_{Y} may represent Y transactions (or another suitable event) between multiple entities occurring on a particular day or hour (or another suitable period of time) represented by time stamp t_{A}, and in graph G_{B}, each node may represent an entity, and each edge may represent a transaction between the nodes connected by the edge occurring on a particular day or hour (or another suitable period of time) represented by time stamp t_{B}. It is noted that because each time-stamped graph represents events associated with a time stamp, the time-stamped graph is independent of any events before or after the associated time stamp. As discussed above, the events represented in graph G_{A} do not overlap with the events represented in graph G_{B}. This is because each graph represents a snapshot of events occurring during a suitable period of time represented by the time stamp associated with the graph. The entities represented in graph G_{A}, however, may or may not overlap with the entities represented in graph G_{B}. This is because the same entities or a subset of the entities may be involved in the different events represented by graph G_{A} and graph G_{B}.

Similarly, graph G_{N} includes nodes and edges representing events from data entry N. For example, the events N₁, N₂, . . . , N_{Z} may represent Z transactions (or another suitable event) between multiple entities occurring on a particular day or hour (or another suitable period of time) represented by time stamp t_{N}, and in graph G_{N}, each node may represent an entity, and each edge may represent a transaction between the nodes connected by the edge occurring on a particular day or hour (or another suitable period of time) represented by time stamp t_{N}. It is noted that because each time-stamped graph represents events associated with a time stamp, the time-stamped graph is independent of any events before or after the associated time stamp. As discussed above, the events represented in graph G_{N} do not overlap with the events represented in graph G_{A} or graph G_{B}. This is because each graph represents a snapshot of events occurring during a suitable period of time represented by the time stamp associated with the graph. The entities represented in graph G_{N}, however, may or may not overlap with the entities represented in graph G_{A} or graph G_{B}. This is because the same entities or a subset of the entities may be involved in the different events represented by graph G_{N}, graph G_{A}, and graph G_{B}.

In some embodiments, each time-stamped graph may be converted into a set of graph embeddings suitable for applying one or more machine learning techniques. As referred to herein, graph embeddings may include information regarding graph topology, node-to-node relationship, and other relevant information about graphs, subgraphs, and nodes. In one example, each node may be encoded with its own vector representation using techniques such as DeepWalk, node2vec, SDNE, etc. This embedding may be used to perform visualization or prediction on the node level, e.g., visualization of nodes in the 2D plane, or prediction of new connections based on node similarities. In another example, the whole graph may be represented with a single vector using techniques such as graph2vec, etc. Those embeddings may be used to make predictions on the graph level and to compare or visualize the whole graphs. While graphs are a meaningful and understandable representation of data, graph embeddings may be more suitable for applying machine learning techniques. Machine learning on graphs is limited. Because graphs consist of edges and nodes, those network relationships can only use a specific subset of mathematics, statistics, and machine learning. On the other hand, vector spaces have a richer toolset of approaches. Further, graph embeddings are compressed representations and can pack node properties in a vector with a smaller dimension. As a result, vector operations are simpler and faster than comparable operations on graphs.

As referred to herein, a “data entry” may include a row, a column, or another suitable portion of tabular data. For example, the data entry may include information regarding a transaction between one or more entities.

As referred to herein, an “event” may be represented in a data entry and may include information regarding a transaction between one or more entities. For example, an event may include information regarding transactions occurring between entities, amounts, number of transactions, etc. In another example, an event may include information regarding a number of times a user clicked on an advertisement tied to a loan product, a credit card, etc.

As referred to herein, a “change point” may indicate a structural change, such as abrupt level shifts or trend slope changes occurring among the data entries in the tabular data. As a part of data monitoring, it may be important to identify these change points, in terms of which variables exhibit such changes, and at what time stamps do the change points occur.

In some embodiments, the system may represent time series datasets or data entries in tabular form via the graph representations described herein such that it exploits graph embeddings to identify change points and anomalies at a certain point in time. The associated time-stamped graphs may represent in one example transactions occurring between entities, amounts, number of transactions, etc. In another example, the time-stamped graphs may represent a number of times a user clicked on an advertisement tied to a loan product, a credit card, etc. The associated time stamps may occur every minute, hour, day, week, month, or another suitable interval. For example, the time stamps may be associated with transactions occurring during a particular day. In another example, the time stamps may be associated with credit reports generated every month. The graph-based approach described herein may be used to identify change points to aid in fraud detection, money laundering, marketing analyses, etc. In some embodiments, the system may identify change points using a method based on a Bayesian minimum descriptive length (BMDL) framework, described further in Yingbo Li, Robert Cezeaux, Di Yu, “Automating Data Monitoring: Detecting Structural Breaks in Time Series Data Using Bayesian Minimum Description Length,” arXiv:1910.01793, which is incorporated herein by reference.

The described systems and methods address the technical problem of how to predict change points from time-stamped tabular data. The solution to this technical problem, in some embodiments, includes generating sets of graph embeddings from the tabular data and processing the sets of graph embeddings using a machine learning model to predict the occurrence of a change point on a node level basis. Solving this technical problem provides the practical benefit of improving prediction of change points from time-stamped tabular data. Conventional systems for analyzing time-stamped tabular data to predict change points looked at each row or data entry independently, while the graph-based approach leverages relationships across rows to predict change points on a node level basis. Conventional systems did not contemplate graphing time-stamped tabular data and converting the subsequent graphs to sets of graph embeddings per time stamp for analysis.

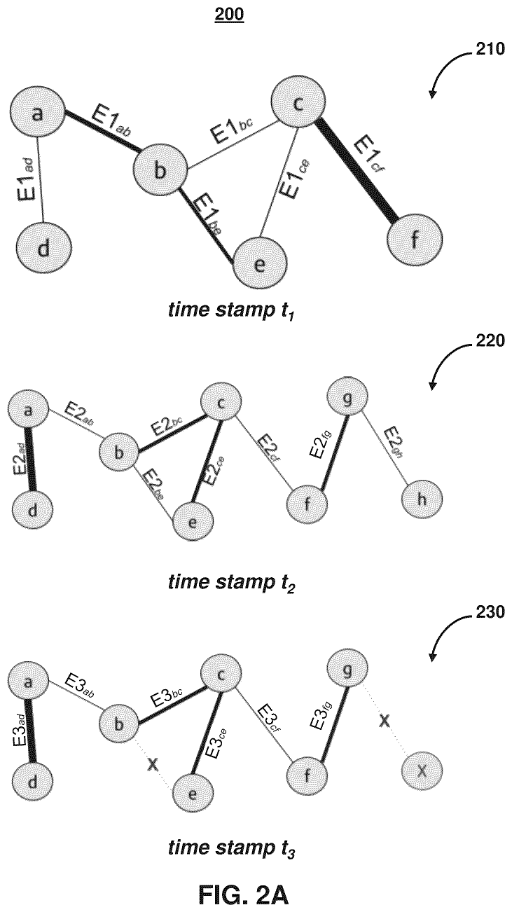

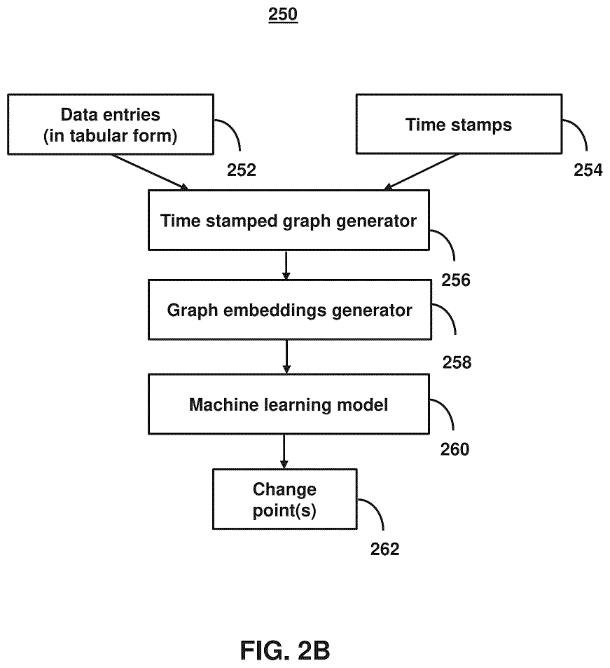

FIG. 2A shows an illustrative diagram 200 for time-stamped graphs (such as those described with respect to FIG. 1) generated based on data entries from tabular data, in accordance with one or more embodiments. The system may receive in tabular form data entries and corresponding time stamps t₁, t₂, and t₃. A data entry of the data entries may include one or more events associated with a time stamp corresponding to the data entry. The system may generate time-stamped graphs 210, 220, and 230 based on the data entries. Each graph of the time-stamped graphs 210, 220, and 230 may correspond to a data entry of the data entries and be representative of one or more events associated with a time stamp corresponding to the data entry. The graph may be independent of any events before or after the time stamp.

In FIG. 2A, the time-stamped graph 210 is associated with time stamp t₁ and includes edges a, b, c, d, e, and f and associated edges E1_{ab}, E1_{bc}, E1_{cf}, E1_{ad}, E1_{be}, and E1_{ec}. The time-stamped graph 220 is associated with time stamp t₂ and includes edges a, b, c, d, e, f, g, and h and associated edges E2_{ab}, E2_{bc}, E2_{cf}, E2_{fg}, E2_{gh}, E2_{ad}, E2_{be}, and E2_{ce}. The time-stamped graph 230 is associated with time stamp t₃ and includes edges a, b, c, d, e, f, g, and h and associated edges E3_{ab}, E3_{bc}, E3_{cf}, E3_{fg}, E3_{ad}, and E3_{ce}. It is noted that the time-stamped graph 210 is independent of any events before or after associated time stamp t₁. Similarly, the time-stamped graph 220 is independent of any events before or after associated time stamp t₂, which is different from the time stamp t₁ associated with the graph 210. Similarly, the time-stamped graph 230 is independent of any events before or after associated time stamp t₃, which is different from the time stamp t₁ associated with the time-stamped graph 210 and the time stamp t₂ associated with the time-stamped graph 220.

The system may generate, for each graph of the time-stamped graphs 210, 220, and 230, a set of graph embeddings based on the graph. The set of graph embeddings may represent nodes and edges of the graph at a time stamp associated with the graph. The system may use a machine learning model to process sets of graph embeddings for the time-stamped graphs 210, 220, and 230 to predict an occurrence of a change point for a node common to the time-stamped graphs and determine a time stamp associated with the predicted occurrence of the change point for the node. The machine learning model may include a Euclidean distance-based model, a naive Bayesian model, an encoder-decoder model, or another suitable machine learning model. By doing so, the system may accurately predict change points in the tabular data.

The time stamp associated with the predicted occurrence of the change point for the node may be determined by identifying a graph of the time-stamped graphs that includes an instance of the node associated with the predicted occurrence of the change point for the node and identifying a time stamp associated with the graph as the time stamp associated with the predicted occurrence of the change point for the node. For example, the system may identify that the time-stamped graph 230 includes an instance of the node “e” associated with the predicted occurrence of the change point for the node. The system may identify the time stamp t₃ associated with the time-stamped graph 230 as the time stamp associated with the predicted occurrence of the change point for the node.

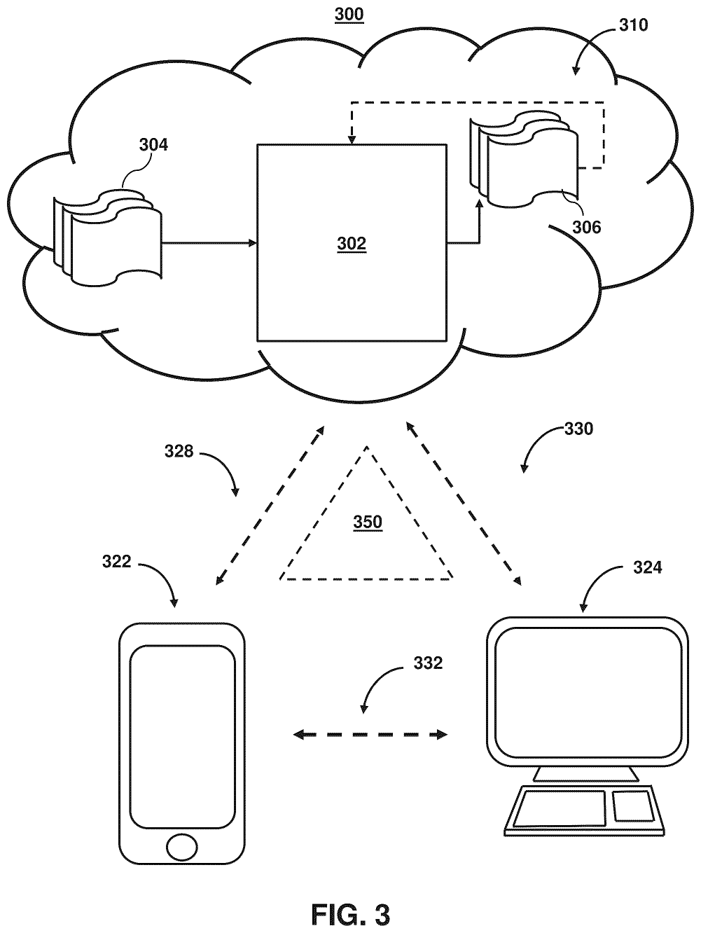

FIG. 2B shows an illustrative diagram 250 for predicting change points in tabular data, in accordance with one or more embodiments. The system may receive in tabular form data entries 252 and time stamps 254. A data entry of the data entries may include one or more events associated with a time stamp corresponding to the data entry. The system may provide the data entries and corresponding time stamps to time-stamped graph generator 256 (e.g., implemented using one or more components described with respect to FIG. 3) to generate time-stamped graphs based on the data entries 252 (e.g., time-stamped graphs 210, 220, and 230). Each graph may correspond to a data entry of the data entries and be representative of one or more events associated with a time stamp corresponding to the data entry. The graph may be independent of any events before or after the time stamp.

The system may provide the time-stamped graphs to graph embeddings generator 258 (e.g., implemented using one or more components described with respect to FIG. 3) to generate, for each graph, a set of graph embeddings based on the graph. The set of graph embeddings may represent nodes and edges of the graph at a time stamp associated with the graph. The system may provide the sets of graph embeddings to a machine learning model 260 (e.g., implemented using one or more components described with respect to FIG. 3) to process the sets of graph embeddings for the time-stamped graphs to predict an occurrence of a change point 262 for a node common to the time-stamped graphs. The system may determine a time stamp associated with the predicted occurrence of the change point 262 for the node. The machine learning model may include a Euclidean distance-based model, a naive Bayesian model, an encoder-decoder model, or another suitable machine learning model. By doing so, the system may accurately predict change points in the tabular data.

FIG. 3 shows illustrative components for a system used to predict change points in tabular data, in accordance with one or more embodiments. For example. FIG. 3 may show illustrative components for identifying change points in tabular data for fraud detection, money laundering, marketing analyses, etc. As shown in FIG. 3, system 300 may include mobile device 322 and user terminal 324. While shown as a smartphone and a personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen devices, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 30) may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include components for generating time-stamped graphs, generating graph embeddings, and generating a machine learning model for predicting change points in tabular data. Cloud components 310 may access data entries from the tabular data in order to generate corresponding time-stamped graphs. Cloud components 310 may include model 302, which may be a machine learning model, artificial intelligence model, etc. (which may be referred to collectively herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., one or more change points in the tabular data).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., one or more change points in the tabular data).

In some embodiments, the model (e.g., model 302) may automatically perform actions based on outputs 306. In some embodiments, the model (e.g., model 302) may not perform any actions. The output of the model (e.g., model 302) may be used to identify one or more change points in the tabular data.

System 300 also includes API layer 350. API layer 350 may allow the system to generate summaries across different devices. In some embodiments. API layer 350 may be implemented on mobile device 322 or user terminal 324. Alternatively or additionally. API layer 350 may reside on one or more of cloud components 310. API layer 350 (which may be a REST or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract, instead, they are documented with client libraries for most common languages, including Ruby, Java, PHP, and JavaScript. SOAP web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

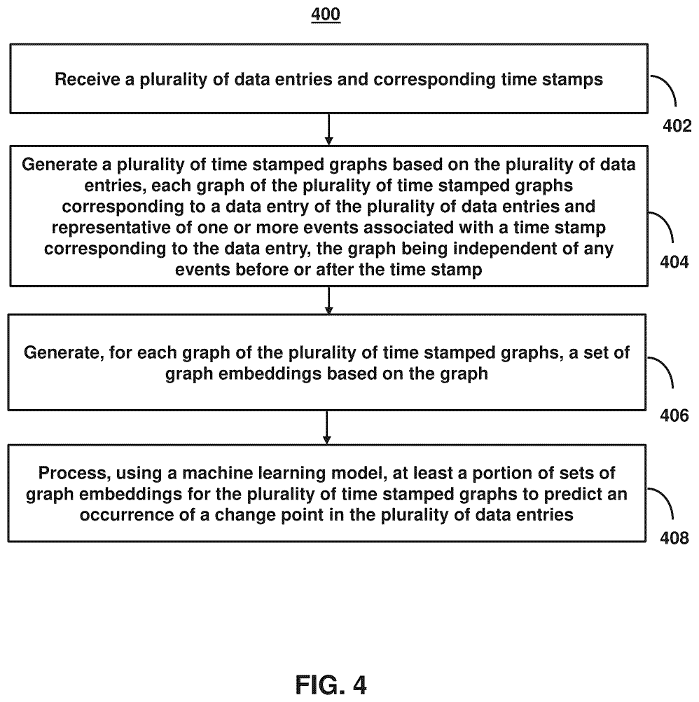

FIG. 4 shows a flowchart of the steps involved in predicting change points in tabular data, in accordance with one or more embodiments. For example, the system may use process 400 (e.g., as implemented on one or more system components described above) in order to predict change points in tabular data.

At step 402, process 400 (e.g., using one or more components described above) receives a plurality of data entries and corresponding time stamps. For example. FIG. 1 shows data entries 102, 104, and 106 (corresponding to data entries A, B, and N) and associated time-stamped graphs 152, 154, and 156 (corresponding to graphs G_{A}, G_{B}, and G_{N}). In some embodiments, the data entries and associated time-stamped graphs may be received separately (e.g., from different sources, or in different files, etc.). In some embodiments, the data entries and associated time-stamped graphs may be received together (e.g., from the same source, or in the same file, etc.). In some embodiments, the data entries may be received, and the associated time-stamped graphs may be subsequently generated. In some embodiments, the data entries may be received at a remote location, the associated time-stamped graphs may be generated at the remote location, and only the time-stamped graphs may be received from the remote location.

At step 404, process 400 generates a plurality of time-stamped graphs based on the plurality of data entries. For example, the system may generate time-stamped graphs 210, 220, and 230 shown in FIG. 2A. Each graph of the time-stamped graphs 210, 220, and 230 may correspond to a data entry of the plurality of data entries and be representative of one or more events associated with a time stamp corresponding to the data entry. The graph may be independent of any events before or after the time stamp. For example, the time-stamped graph 210 may be independent of any events before or after associated time stamp t₁. Similarly, the time-stamped graph 220 may be independent of any events before or after associated time stamp t₂, which is different from the time stamp t₁ associated with the graph 210. Similarly, the time-stamped graph 230 may be independent of any events before or after associated time stamp t₃, which is different from the time stamp t₁ associated with the time-stamped graph 210 and the time stamp t₂ associated with the time-stamped graph 220.

At step 406, process 400 generates, for each graph of the plurality of time-stamped graphs, a set of graph embeddings based on the graph. For example, the system may generate, for each graph of the time-stamped graphs 210, 220, and 230 shown in FIG. 2A, a set of graph embeddings based on the graph. In some embodiments, the set of graph embeddings represents nodes and edges of the graph at a time stamp associated with the graph. The graph embeddings may capture information regarding graph topology, node-to-node relationship, and other relevant information about graphs, subgraphs, and nodes. While graphs are a meaningful and understandable representation of data, graph embeddings may be more suitable for applying machine learning techniques. Machine learning on graphs is limited. Because graphs consist of edges and nodes, those network relationships can only use a specific subset of mathematics, statistics, and machine learning. On the other hand, vector spaces have a richer toolset of approaches. Further, graph embeddings are compressed representations and can pack node properties in a vector with a smaller dimension. As a result, vector operations are simpler and faster than comparable operations on graphs.

At step 408, process 400 processes, using a machine learning model, at least a portion of sets of graph embeddings for the plurality of time-stamped graphs to predict an occurrence of a change point in the plurality of data entries. For example, the system may use a machine learning model to process sets of graph embeddings for the time-stamped graphs 210, 220, and 230 shown in FIG. 2A to predict an occurrence of a change point for a node common to the time-stamped graphs and determine a time stamp associated with the predicted occurrence of the change point for the node. In some embodiments, the machine learning model comprises a Euclidean distance-based model, a naive Bayesian model, or an encoder-decoder model. By doing so, the system may accurately predict change points in the tabular data.

In some embodiments, the system determines the time stamp associated with the predicted occurrence of the change point for the node by identifying a graph of the plurality of time-stamped graphs that includes an instance of the node associated with the predicted occurrence of the change point for the node and identifying a time stamp associated with the graph as the time stamp associated with the predicted occurrence of the change point for the node. For example, the system may identify that the time-stamped graph 230 in FIG. 2A includes an instance of the node “e” associated with the predicted occurrence of the change point for the node. The system may identify the time stamp t₃ associated with the time-stamped graph 230 as the time stamp associated with the predicted occurrence of the change point for the node.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

The present techniques will be better understood with reference to the following enumerated embodiments:
1. A method, the method comprising: receiving in tabular form a plurality of data entries and corresponding time stamps, each data entry of the plurality of data entries including one or more events associated with a time stamp corresponding to the data entry; generating a plurality of time-stamped graphs based on the plurality of data entries, each graph of the plurality of time-stamped graphs corresponding to a data entry of the plurality of data entries and representative of one or more events associated with a time stamp corresponding to the data entry, the graph being independent of any events before or after the time stamp; generating, for each graph of the plurality of time-stamped graphs, a set of graph embeddings based on the graph, the set of graph embeddings representing nodes and edges of the graph at a time stamp associated with the graph; processing, using a machine learning model, sets of graph embeddings for the plurality of time-stamped graphs to predict an occurrence of a change point for a node common to the plurality of time-stamped graphs; and determining a time stamp associated with the predicted occurrence of the change point for the node.
2. A method, the method comprising: receiving a plurality of data entries and corresponding time stamps; generating a plurality of time-stamped graphs based on the plurality of data entries, each graph of the plurality of time-stamped graphs corresponding to a data entry of the plurality of data entries and representative of one or more events associated with a time stamp corresponding to the data entry, the graph being independent of any events before or after the time stamp; generating, for each graph of the plurality of time-stamped graphs, a set of graph embeddings based on the graph; and processing, using a machine learning model, at least a portion of sets of graph embeddings for the plurality of time-stamped graphs to predict an occurrence of a change point in the plurality of data entries.
3. The method of any one of the preceding embodiments, wherein predicting the occurrence of the change point comprises: predicting the occurrence of the change point for a node common to at least some of the plurality of time-stamped graphs.
4. The method of any one of the preceding embodiments, further comprising: determining a time stamp associated with the predicted occurrence of the change point for the node.
5. The method of any one of the preceding embodiments, wherein determining the time stamp associated with the predicted occurrence of the change point for the node comprises: identifying a graph of the plurality of time-stamped graphs that includes an instance of the node associated with the predicted occurrence of the change point for the node; and identifying a time stamp associated with the graph as the time stamp associated with the predicted occurrence of the change point for the node.
6. The method of any one of the preceding embodiments, wherein the set of graph embeddings represents nodes and edges of the graph at a time stamp associated with the graph.
7. The method of any one of the preceding embodiments, wherein the machine learning model comprises a Euclidean distance-based model, a naive Bayesian model, or an encoder-decoder model.
8. A tangible, non-transitory, machine-readable medium storing instructions that, when executed by a data processing apparatus, cause the data processing apparatus to perform operations comprising those of any of embodiments 1-7.
9. A system comprising one or more processors; and memory storing instructions that, when executed by the processors, cause the processors to effectuate operations comprising those of any of embodiments 1-7.
10. A system comprising means for performing any of embodiments 1-7.

What is claimed is:

1. A system for predicting one or more change points in time-stamped tabular data representing events occurring at different times, the system comprising:
one or more processors; and
a non-transitory, computer-readable medium comprising instructions that, when executed by the one or more processors, cause operations comprising:
receiving in tabular form a plurality of data entries and corresponding time stamps,
each data entry of the plurality of data entries including one or more events associated with a time stamp corresponding to the data entry;
generating a plurality of time-stamped graphs based on the plurality of data entries,
each graph of the plurality of time-stamped graphs corresponding to a data entry of the plurality of data entries and representative of one or more events associated with a time stamp corresponding to the data entry,
the graph being independent of any events before or after the time stamp:
generating, for each graph of the plurality of time-stamped graphs, a set of graph embeddings based on the graph, the set of graph embeddings representing nodes and edges of the graph at a time stamp associated with the graph;
processing, using a machine learning model, sets of graph embeddings for the plurality of time-stamped graphs to predict an occurrence of a change point for a node common to the plurality of time-stamped graphs; and
determining a time stamp associated with the predicted occurrence of the change point for the node.

2. The system of claim 1, wherein determining the time stamp associated with the predicted occurrence of the change point for the node comprises:
identifying a graph of the plurality of time-stamped graphs that includes an instance of the node associated with the predicted occurrence of the change point for the node; and
identifying a time stamp associated with the graph as the time stamp associated with the predicted occurrence of the change point for the node.

3. The system of claim 1, wherein the machine learning model comprises:
a Euclidean distance-based model,
a naive Bayesian model, or
an encoder-decoder model.

4. A method comprising:
receiving a plurality of data entries and corresponding time stamps;
generating a plurality of time-stamped graphs based on the plurality of data entries,
each graph of the plurality of time-stamped graphs corresponding to a data entry of the plurality of data entries and representative of one or more events associated with a time stamp corresponding to the data entry,
the graph being independent of any events before or after the time stamp;
generating, for each graph of the plurality of time-stamped graphs, a set of graph embeddings based on the graph; and
processing, using a machine learning model, at least a portion of sets of graph embeddings for the plurality of time-stamped graphs to predict an occurrence of a change point in the plurality of data entries.

5. The method of claim 4, wherein predicting the occurrence of the change point comprises:
predicting the occurrence of the change point for a node common to at least some of the plurality of time-stamped graphs.

6. The method of claim 5, further comprising:
determining a time stamp associated with the predicted occurrence of the change point for the node.

7. The method of claim 6, wherein determining the time stamp associated with the predicted occurrence of the change point for the node comprises:
identifying a graph of the plurality of time-stamped graphs that includes an instance of the node associated with the predicted occurrence of the change point for the node; and
identifying a time stamp associated with the graph as the time stamp associated with the predicted occurrence of the change point for the node.

8. The method of claim 4, wherein the set of graph embeddings represents nodes and edges of the graph at a time stamp associated with the graph.

9. The method of claim 4, wherein the machine learning model comprises:
a Euclidean distance-based model,
a naive Bayesian model, or
an encoder-decoder model.

10. A non-transitory, computer-readable medium comprising instructions that, when executed by one or more processors, cause operations comprising:
receiving a plurality of data entries and corresponding time stamps;
generating a plurality of time-stamped graphs based on the plurality of data entries,
each graph of the plurality of time-stamped graphs corresponding to a data entry of the plurality of data entries and representative of one or more events associated with a time stamp corresponding to the data entry,
the graph being independent of any events before or after the time stamp;
generating, for each graph of the plurality of time-stamped graphs, a set of graph embeddings based on the graph; and
processing, using a machine learning model, at least a portion of sets of graph embeddings for the plurality of time-stamped graphs to predict an occurrence of a change point in the plurality of data entries.

11. The non-transitory, computer-readable medium of claim 10, wherein predicting the occurrence of the change point comprises:
predicting the occurrence of the change point for a node common to at least some of the plurality of time-stamped graphs.

12. The non-transitory, computer-readable medium of claim 11, wherein the instructions cause further operations comprising:
determining a time stamp associated with the predicted occurrence of the change point for the node.

13. The non-transitory, computer-readable medium of claim 12, wherein determining the time stamp associated with the predicted occurrence of the change point for the node comprises:
identifying a graph of the plurality of time-stamped graphs that includes an instance of the node associated with the predicted occurrence of the change point for the node; and
identifying a time stamp associated with the graph as the time stamp associated with the predicted occurrence of the change point for the node.

14. The non-transitory, computer-readable medium of claim 10, wherein the set of graph embeddings represents nodes and edges of the graph at a time stamp associated with the graph.

15. The non-transitory, computer-readable medium of claim 10, wherein the machine learning model comprises:
a Euclidean distance-based model,
a naive Bayesian model, or
an encoder-decoder model.
